(19) United States
(12) Patent Application Publication
(10) Pub. No.: US 2026/0161871 A1
(43) Pub. Date: Jun. 11, 2026

(54) METHOD, A PROGRAM, AND A COMPUTER FOR TIMING ADJUSTMENT OF A SEMICONDUCTOR INTEGRATED CIRCUIT DEVICE

(71) Applicant: Renesas Electronics Corporation, Tokyo (JP)

(72) Inventors: Daisuke MARUYAMA, Tokyo (JP); Mitsuru HANDA, Tokyo (JP)

(21) Appl. No.: 19/357,222

(22) Filed: Oct. 14, 2025

(30) Foreign Application Priority Data
Dec. 11, 2024 (JP) 2024-216232

(51) Int. Cl. G06F 30/3312; G06F 30/392; G06F 119/12

(52) U.S. Cl. CPC G06F 30/3312; G06F 30/392; G06F 2119/12

(57) ABSTRACT

The timing adjustment method, program, and computer for a semiconductor integrated circuit are provided to suppress the increase in the size of layout data. The timing adjustment method for a semiconductor integrated circuit includes adding one or more dummy cells each having a plurality of dummy metals to layout data of the semiconductor integrated circuit, selecting a dummy cell to be connected to a signal wiring when the delay time of the signal wiring included in the layout data indicates a hold error, and connecting one or more of the plurality of dummy metals included in the dummy cell that has been selected in the selecting to the signal wiring.

### CROSS-REFERENCE TO RELATED APPLICATIONS

The disclosure of Japanese Patent Application No. 2024-216232 filed on Dec. 11, 2024, including the specification, drawings and abstract is incorporated herein by reference in its entirety.

### BACKGROUND

The present invention relates to a method, program, and computer for timing adjustment of a semiconductor integrated circuit device.

There are disclosed techniques listed below.

[Patent Document 1] Japanese Unexamined Patent Application Publication No. 2009-9247

Patent Document 1 discloses a technique for coupling dummy metal to signal wiring in layout data when the delay time of the signal wiring where a hold error is caused.

### SUMMARY

The technology described in Patent Document 1 may cause to increase the size of the layout data due to the placement information of the dummy metal.

This disclosure seeks to solve such a problem and aims to realize a method, program, and computer for timing adjustment of semiconductor integrated circuits while suppressing the increase in the size of layout data.

Other objects and novel features will become apparent from the description of this specification and the accompanying drawings.

A timing adjustment method for a semiconductor integrated circuit according to one aspect of the present disclosure includes adding one or more dummy cells each having a plurality of dummy metals to layout data of the semiconductor integrated circuit, selecting a dummy cell to be connected to a signal wiring when the delay time of the signal wiring included in the layout data indicates a hold error, and connecting one or more of the plurality of dummy metals included in the dummy cell that has been selected in the selecting to the signal wiring.

A program according to another aspect of the present disclosure causes a computer to execute processes. The processes includes adding one or more dummy cells each having a plurality of dummy metals to layout data of the semiconductor integrated circuit, selecting a dummy cell to be connected to a signal wiring when the delay time of the signal wiring included in the layout data indicates a hold error, and connecting one or more of the plurality of dummy metals included in the dummy cell that has been selected in the selecting to the signal wiring.

A computer according to still another aspect of the present disclosure includes a CPU and a storage unit. The storage unit stores a computer program for executing a plurality of processes on the CPU. The plurality of processes includes adding one or more dummy cells each having a plurality of dummy metals to layout data of the semiconductor integrated circuit, selecting a dummy cell to be connected to a signal wiring when the delay time of the signal wiring included in the layout data indicates a hold error, and connecting one or more of the plurality of dummy metals included in the dummy cell that has been selected in the selecting to the signal wiring.

According to the present invention, it is possible to provide a timing adjustment method, program, and computer for semiconductor integrated circuits while suppressing the increase in the size of layout data.

### BRIEF DESCRIPTION OF THE DRAWINGS

FIG. 1 is a schematic diagram illustrating the layout of a semiconductor integrated circuit after placement and routing have been performed.

FIG. 2 is a schematic diagram showing an example of the arrangement of conventional dummy metal.

FIG. 3 is a schematic diagram showing an outline of the embodiment.

FIG. 4 is a block diagram illustrating the configuration of a system to which the timing adjustment method according to the first embodiment is applied.

FIG. 5 is a flowchart showing the timing adjustment method of the semiconductor integrated circuit according to the first embodiment.

FIG. 6 is a schematic diagram illustrating a dummy cell according to the first embodiment.

FIG. 7 is a schematic diagram showing dummy metal connected to signal wiring.

FIG. 8 is a schematic diagram showing dummy metal connected to signal wiring.

FIG. 9 is a schematic diagram illustrating a dummy cell according to the second embodiment.

FIG. 10 is a schematic diagram showing dummy metal connected to signal wiring.

FIG. 11 is a flowchart showing the timing adjustment method of the semiconductor integrated circuit according to the fourth embodiment.

### DETAILED DESCRIPTION

For clarity of explanation, the following descriptions and drawings are appropriately omitted and simplified. In each drawing, the same elements are denoted by the same reference numerals, and repetitive descriptions are omitted as necessary. Each element described in the drawings as a functional block for performing various processes can be configured in hardware as a CPU (Central Processing Unit), memory, and other circuits, and in software, it can be realized by programs loaded into memory. Therefore, it is understood by those skilled in the art that these functional blocks can be realized in various forms by hardware, software operating on hardware, or a combination thereof, and are not limited to any one form.

### Overview of Embodiments

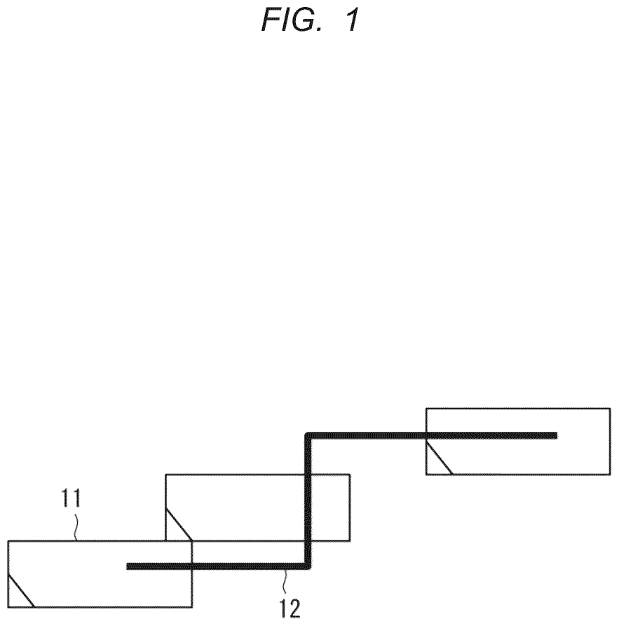

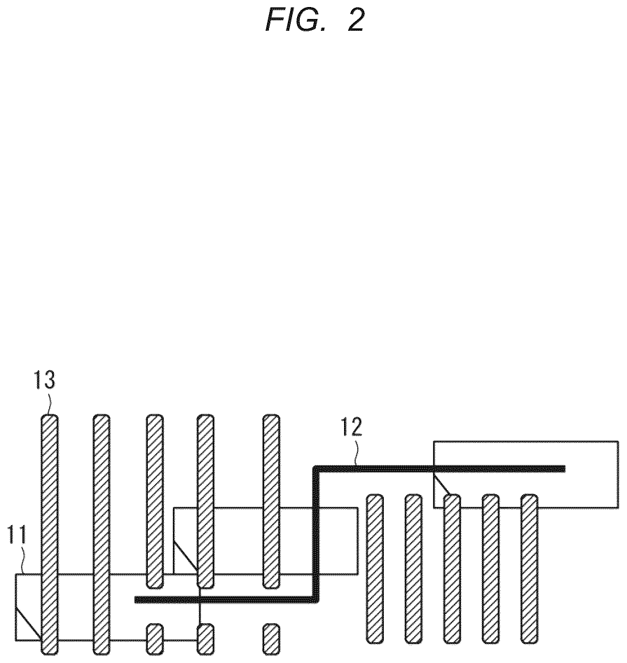

FIG. 1 illustrates the layout of a semiconductor integrated circuit after placement and routing. In the placement and routing process, the path of the signal wiring 12 coupling a plurality of standard cells 11 is determined. The standard cells 11 constitute circuits such as AND circuits and OR circuits. As shown in FIG. 2, to suppress variations in the metal density in the wiring layer where the signal wiring 12 is provided, a plurality of dummy metals 13 are added to the vacant areas of the wiring layer where the signal wiring 12 is provided. The dummy metals 13 may have different shapes from each other. Since data representing the position and shape of each dummy metal 13 is added to the layout data, the data size of the layout data increases.

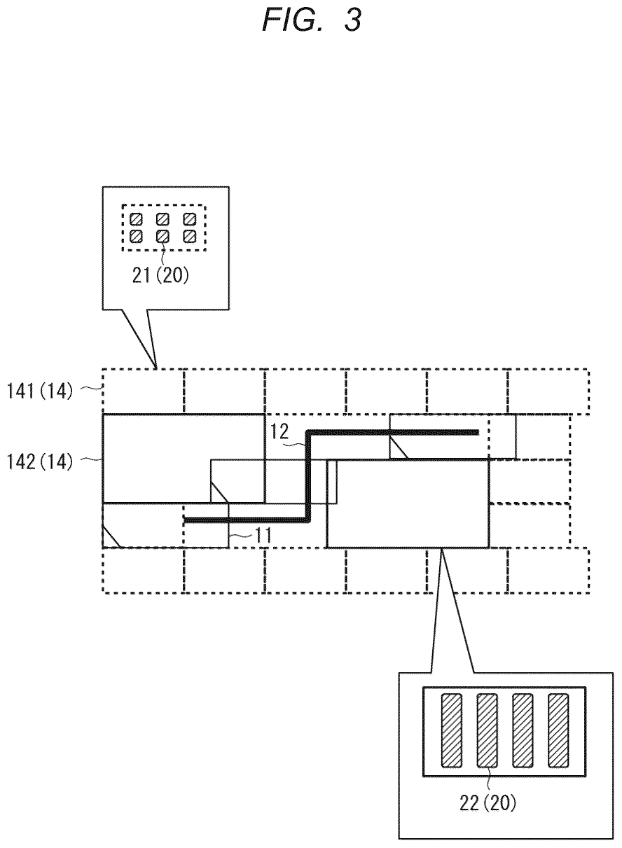

In the embodiment, as shown in FIG. 3, instead of dummy metals 13, dummy cells 14 are arranged in the vacant areas of the wiring layer where the signal wiring 12 is provided. Each of the dummy cells 141 and 142 is an example of the dummy cell 14. The dummy cell 141 is enclosed by a dotted line, and the dummy cell 142 is enclosed by a solid line. The size of the dummy cell 141 is smaller than that of the dummy cell 142. In FIG. 3, two types of dummy cells 14 are added to the layout, but one type of dummy cell 14 may be added to the layout.

In the dummy cell 14, a plurality of dummy metals 20 are arranged. For example, in dummy cell 141, six dummy metals 21 with a square shape are arranged. In the dummy cell 142, four dummy metals 22 with a rectangular shape are arranged. The metal density of the dummy metals 21 and the metal density of the dummy metals 22 are different.

The dummy cells 14 are arranged to avoid the signal wiring 12. The dummy cells 14 and the standard cells 11 may overlap as long as the position of the pins of the standard cell 11 and the position of the dummy metal 20 satisfy the DRC (Design Rule Check).

In the embodiment, the delay time of the signal wiring 12 is increased by connecting the signal wiring 12 and the dummy metal 20. According to the embodiment, since a plurality of dummy metals 20 are grouped into one dummy cell 14, the data size of the layout data is reduced. For example, if the number of dummy metals 20 arranged in the dummy cell 14 is six, conventionally, data representing the position and shape of each of the six dummy metals 20 is added to the layout data. However, according to the embodiment, the dummy metals 20 are treated as one dummy cell 14. Therefore, it is sufficient to add data representing the position and shape of the dummy cell 14 to the layout data, so that the size of the data related to the dummy metals 20 is compressed to one-sixth compared to the size of the data representing the position and shape of each of the six dummy metals 20. If the dummy metals 20 within the dummy cell 14 have the same shape, the increase in delay time of the signal wiring 12 can be set with high precision based on the number of dummy metals 20 to be connected to the signal wiring 12.

### First Embodiment

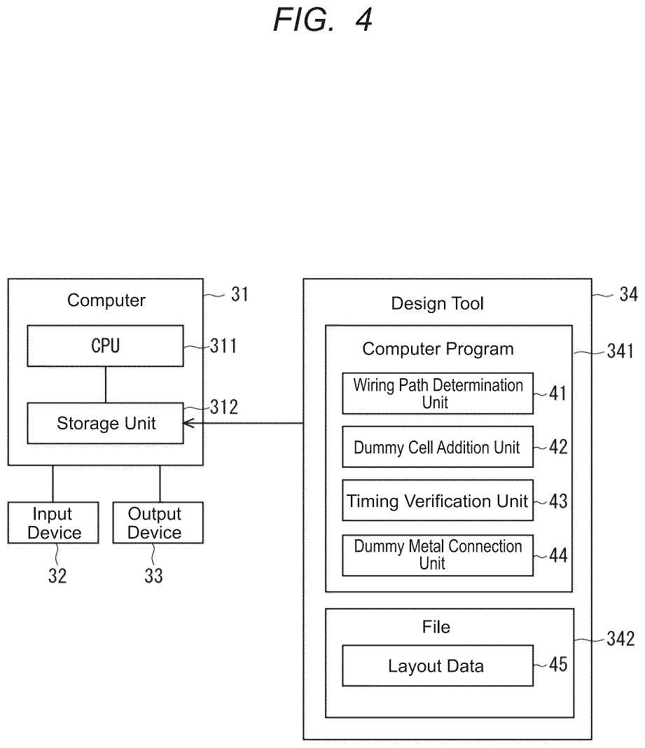

FIG. 4 is a block diagram illustrating the configuration of a system to which the timing adjustment method of the semiconductor integrated circuit according to the first embodiment is applied. The system shown in FIG. 4 includes a computer 31, an input device 32, and an output device 33. The input device 32 and the output device 33 are connected to the computer 31. The output device 33 may include a display device and a printing device. The layout data 45 may be generated in response to input to the input device 32.

The computer 31 includes a CPU 311 and a storage unit 312. The storage unit 312 stores a computer program 341. The CPU 311 executes the computer program 341.

The system shown in FIG. 4 includes a design tool 34, which is software. The design tool 34 is installed in storage unit 312. The design tool 34 includes a computer program 341 and a file 342. The file 342 includes layout data 45. The layout data 45 represents the position of each component arranged in the integrated circuit. The components may include standard cells, signal wirings, and dummy cells. The position may be the coordinates of each component arranged in a predetermined coordinate area. The computer program 341 includes a wiring path determination unit 41, a dummy cell addition unit 42, a timing verification unit 43, and a dummy metal connection unit 44, which will be described later.

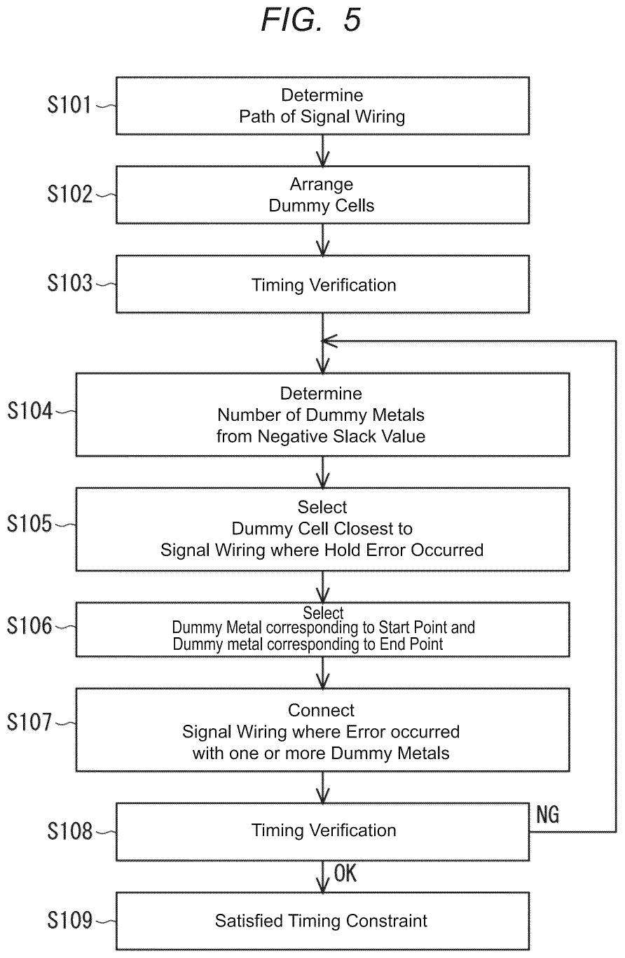

FIG. 5 is a flowchart illustrating the timing adjustment method for a semiconductor integrated circuit according to the first embodiment.

First, the wiring path determination unit 41 determines the paths of the signal wirings 12 that connects the standard cells 11 to each other (step S101). Next, the dummy cell addition unit 42 adds dummy cells 14, which include a plurality of dummy metals 20, respectively, to the layout data 45. The dummy cell addition unit 42 arranges the dummy cells 14 in the vacant area of the wiring layer of the signal wirings 12 arranged in the path determined in step S101 (step S102).

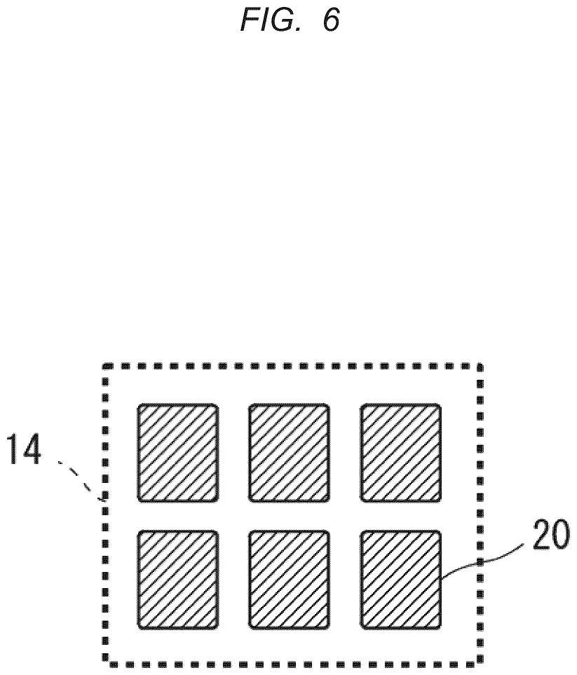

FIG. 6 is a schematic diagram illustrating an example of dummy cell 14. Six dummy metals 20 are arranged within dummy cell 14. The six dummy metals 20 are arranged in a 2-row by 3-column array. Each dummy metal 20 has a square shape. The interval between adjacent dummy metals 20 may be constant. By arranging the dummy cells 14, variations in metal density are suppressed.

Note that the dummy metal layout pattern of the dummy cell 14 do not need to be identical. As shown in FIG. 3, the dummy cell addition unit 42 may select an appropriate dummy cell from dummy cells 14 having different dummy metal layout patterns that meet the metal density constraints and add it to the layout.

Referring again to FIG. 5, the timing verification unit 43 then performs timing verification for the path determined in step S101 (step S103). If a delay time of a signal wiring 12 in the layout data 45 indicates hold error, the timing verification unit 43 calculates a negative slack value of the signal wiring 12 where the hold error occurred. The slack value is a value obtained by subtracting the constraint value from the delay time of the signal wiring 12. The negative slack value is the slack value when the slack value is negative, and indicates that the delay time in the signal wiring 12 does not meet the constraint conditions. The absolute value of the slack value when it is negative may be referred to as the negative slack value.

Next, the dummy metal connection unit 44 determines the number of dummy metals 20 required to meet the constraint value based on the negative slack value (step S104). The dummy metal connection unit 44 may determine the number of dummy metals 20 by referring to a table that associates the number of dummy metals 20 with the delay time. Alternatively, the dummy metal connection unit 44 may determine the number of dummy metals 20 by dividing the negative slack value by the delay time per dummy metal 20.

Note that the dummy metal connection unit 44 may calculate the delay time corresponding to the distance between the signal wiring 12 where the hold error occurred and the nearest dummy metal 20 based on the resistance and capacitance values of the wiring for that distance. Then, the dummy metal connection unit 44 may subtract the calculated delay time from the negative slack value and determine the number of dummy metals 20 from the subtraction result.

Next, the dummy metal connection unit 44 searches for the dummy cell 14 nearest to the signal wiring 12 where the hold error occurred and selects it (step S105). If the number of dummy metals 20 determined in step S104 exceeds the number of dummy metals 20 included in one dummy cell 14, the dummy metal connection unit 44 may search for a plurality of dummy cells 14 and select them.

Next, the dummy metal connection unit 44 selects the dummy metal 20 corresponding to the start point and the dummy metal 20 corresponding to the end point from among the dummy metals 20 included in the dummy cell 14 selected in step S105 (step S106).

Next, the dummy metal connection unit 44 connects the signal wiring 12 where the hold error occurred with the dummy metal 20 corresponding to the start point selected in step S106 and connects the adjacent dummy metals 20 that are between the dummy metals 20 of the start and end points to each other (step S107). Thus, the dummy metals 20 included in the dummy cell 14 arranged to suppress variations in metal density are used for timing adjustment.

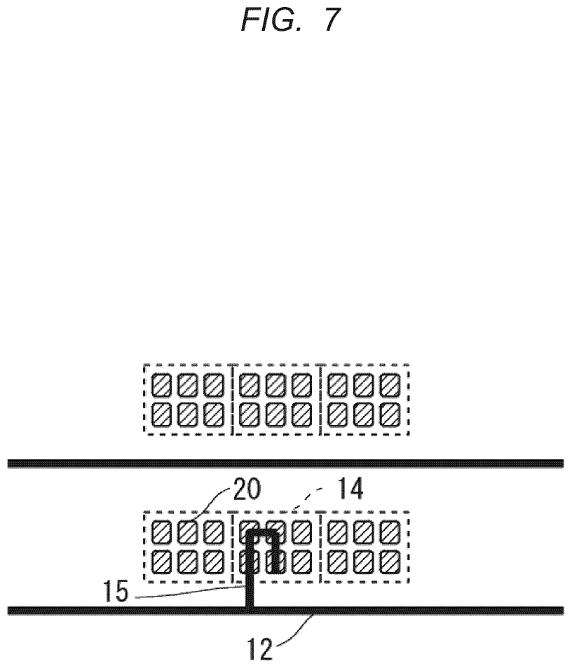

Referring to FIG. 7, when the required number of dummy metals 20 is four, the dummy metal connection unit 44 connects the signal wiring 12 with the dummy wiring 15, which connects four dummy metals 20. By increasing the wiring capacitance, the delay time of the signal wiring 12 is increased. Note that the dummy metal connection unit 44 may further connect the dummy metal 20 corresponding to the end point selected in step S106 to the signal wiring 12, and cut a part of the signal wiring 12 that is located between the point connected to the start point selected in step S106 on the signal wiring 12 and the point connected to the end point selected in step S106 on the signal wiring 12. Thus, the length of the signal wiring 12 may be increased to increase the delay time.

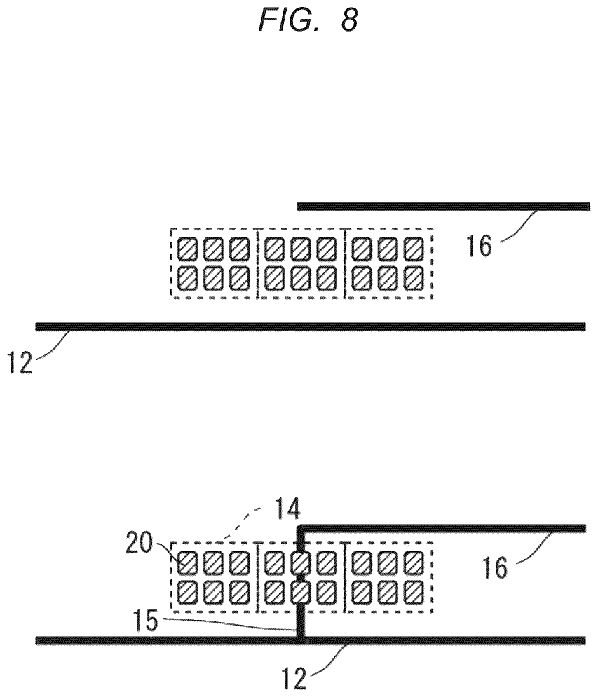

The dummy metals 20 may be used for purposes other than increasing the delay time of the signal wiring 12. For example, when the netlist is updated to connect the signal wiring 12 and the signal wiring 16 from the layout that was arranged as shown in the upper diagram of FIG. 8, the dummy metal connection unit 44 may connect the signal wiring 12 to the signal wiring 16 via the dummy wiring 15, as shown in the lower diagram of FIG. 8. The dummy metals 20 are used as part of the dummy wiring 15.

Referring again to FIG. 5, if a hold error occurs for multiple signal wirings 12 in step S103, steps S104 to S107 may be executed multiple times. The layout data of the dummy cell 14 may have not only information indicating the position and shape but also flag information indicating whether it is connected to the signal wiring 12. In this case, after step S107, the dummy metal connection unit 44 writes information indicating that it has been used in the flag information of the dummy cell 14 that includes the dummy metal(s) 20 connected to the signal wiring 12. In step S105, the dummy metal connection unit 44 may search for the dummy cell 14 nearest to the signal wiring 12 among the dummy cells 14 that have flag information indicating that they are not connected to any signal wiring.

The timing verification unit 43 performs timing verification again after step S107 (step S108). If the timing verification fails (NG in step S108), the dummy metal connection unit 44 increases the number of dummy metals 20 to be connected to the signal wiring 12 (step S104) and executes steps S105 to S108 again. If the timing verification fails in step S108 and it is necessary to connect another dummy cell 14, the additional dummy cell 14 to be connected may be searched by referring to the aforementioned flag information. If the timing verification is successful (OK in step S108), the timing verification unit 43 may output that the timing constraint has been satisfied (step S109). Note that examples not including step S104 may also be included in the first embodiment. For example, the number of dummy metals 20 connected to the signal wiring 12 may be increased one by one until the timing verification is successful in step S108.

In the first embodiment, since the layout data 45 includes data of dummy cell 14 containing multiple dummy metals 20 rather than data for each dummy metal 20, an increase in data size can be prevented.

When multiple dummy metals 20 have the same shape, the delay time of the signal wiring 12 can be accurately set based on the number of dummy metals 20 to be connected to the signal wiring 12. Conventionally, it was necessary to individually calculate the delay time of the dummy metals when connecting dummy metals 20 with various shapes to the signal wiring 12, and the rework was significant if the added delay time was insufficient. The first embodiment can reduce rework and improve TAT (Turn Around Time).

### Second Embodiment

In the second embodiment, each dummy metal 20 has a rectangular shape. Each dummy cells 14 has the dummy metal layout pattern having information of shape and position of the dummy metals 20. The dummy cell to be arranged is selected from the dummy cells 14 having different dummy metal layout patterns. The description overlapping with the first embodiment is omitted.

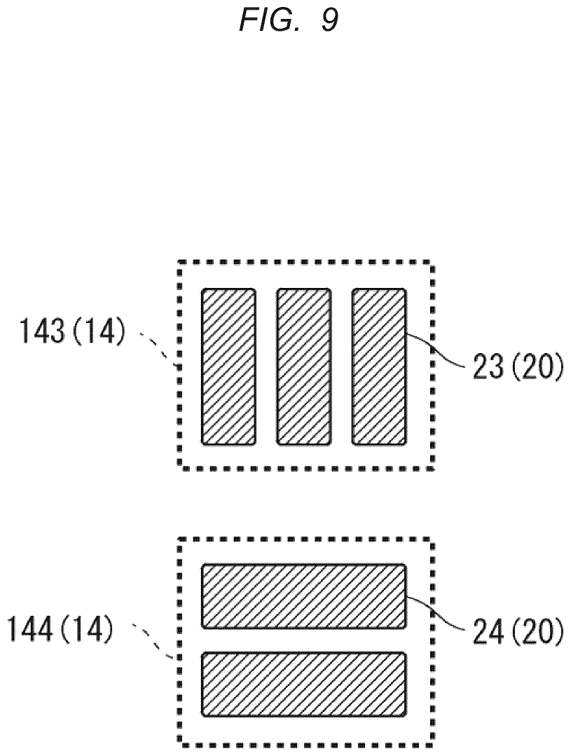

Referring to FIG. 9, each of the dummy metals 23 and 24 is an example of the dummy metal 20. The dummy cell 143 has dummy metals 23 each having a first dummy metal layout pattern, and the dummy cell 144 has dummy metals 24 each having a second dummy metal layout pattern. In the dummy cell 143 with the first dummy metal layout pattern, three dummy metals 23 are arranged in a 1-row by 3-column array. In the dummy cell 144 with the second dummy metal layout pattern, two dummy metals 24 are arranged in a 2-row by 1-column array. One of the directions along the two long sides of the dummy metal 21 included in the dummy cell 141 shown in FIG. 3 and the direction along the long side of the dummy metal 22 included in the dummy cell 142 are the same, but the direction along the long side of the dummy metal 23 is orthogonal to the direction along the long side of the dummy metal 24. The directions along the long sides of the dummy metals 20 among multiple dummy metal layout patterns may be the same.

Referring to FIG. 5, in step S102, the dummy cell addition unit 42 selects the dummy metal layout pattern of the dummy cell 14 to be arranged in the vacant area of the wiring layer of the signal wiring 12 based on the arrangement of the signal wiring 12 determined in step S101. The dummy cell addition unit 42 arranges a dummy cell with an appropriate dummy metal layout pattern to meet the metal density constraints based on the arrangement of the signal wiring 12.

The second embodiment can meet the metal density constraints by adding dummy cells 14 with appropriate dummy metal layout patterns, regardless of the direction along the long side of the dummy metal.

### Third Embodiment

In the third embodiment, timing adjustment of multiple signal lines 12 is performed sharing one dummy cell 14.

Descriptions overlapping with the first embodiment are omitted.

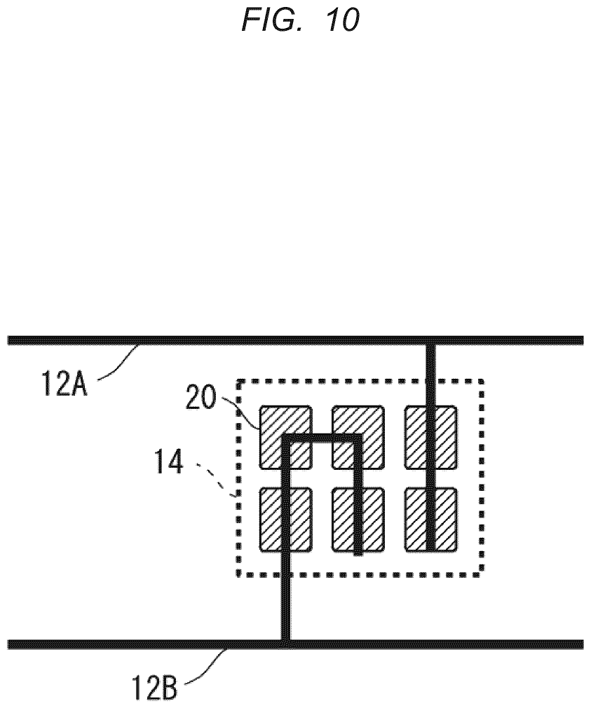

Referring to FIG. 10, in the third embodiment, the dummy cell 14 includes dummy metals 20 connected to the signal wiring 12A and dummy metals 20 connected to the signal wiring 12B. The dummy metal connection unit 44, for example, connects two dummy metals 20 to the signal wiring 12A and four dummy metals 20 to the signal wiring 12B. This allows for efficient use of the dummy metals 20.

For example, the dummy metal connection unit 44 may write information indicating that two dummy metals 20 connected to the signal wiring 12A have been used into their flag information. The flag information may be included in a library that manages the information of dummy cell 14. The dummy metal connection unit 44 selects dummy metals 20 to be connected to the signal wiring 12B from those with flag information indicating they have not been used.

The third embodiment can improve the usage efficiency of the dummy metals 20.

### Fourth Embodiment

The fourth embodiment is a specific example of the first embodiment. Descriptions overlapping with the first embodiment are omitted.

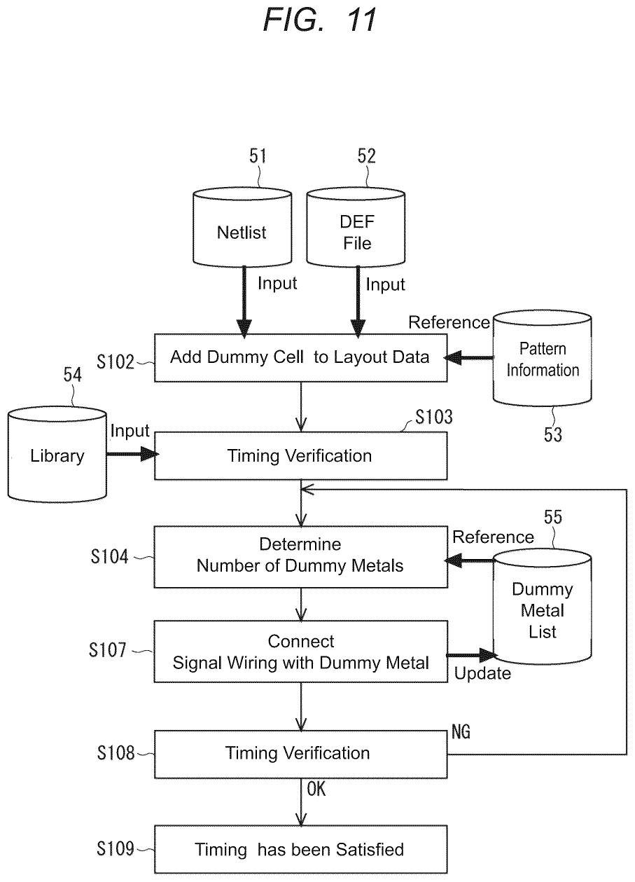

FIG. 11 is a flowchart showing the flow of the timing adjustment method according to the fourth embodiment. Comparing FIG. 5 and FIG. 11, FIG. 11 clarifies the input and output data, and the illustration of some processes is omitted.

In step S102, the dummy cell addition unit 42 inputs a netlist 51 and a Design Exchange Format (DEF) file 52 and refers to pattern information 53 to add the dummy cell 14 to the layout data 45. The netlist 51 shows the connection relationship of standard cells 11. The DEF file 52 includes the position, wiring, and connection information between the standard cells 11. The pattern information 53 indicates the shape and position of the dummy metals 20 in each dummy metal layout pattern of the dummy cell 14.

In step S103, the timing verification unit 43 inputs the library 54 and performs timing verification. The library 54 may include information indicating the delay time in each standard cell 11 and the delay time in each signal wiring 12.

In step S104, the dummy metal connection unit 44 refers to the dummy metal list 55 to determine the necessary number of dummy metals 20. The dummy metal list 55 includes information on the delay time for each number of dummy metals 20 and whether each dummy metal 20 is used.

In step S107, the dummy metal connection unit 44 connects the signal wiring 12 to the dummy metals 20. The dummy metal connection unit 44 registers the usage information of the dummy metals 20 connected to the signal wiring 12 on the dummy metal list 55 and updates the dummy metal list 55.

The fourth embodiment can accommodate various dummy metal layout patterns and update information indicating available dummy metals.

Although the invention made by the present inventor has been specifically described based on the embodiment, the present invention is not limited to the described embodiment, and it is needless to say that various modifications can be made without departing from the gist thereof. Furthermore, the above-described embodiments can be executed in combination. For example, it is possible to realize a combination of some or all of the first to fourth embodiments.

The above-described program, when loaded into a computer, includes a set of instructions (or software code) to cause the computer to perform one or more functions described in the embodiment. The program may be stored in non-transitory computer-readable media or tangible storage media. By way of example and not limitation, the computer-readable media or tangible storage media may include RAM (Random-Access Memory), ROM (Read-Only Memory), flash memory, SSD (Solid-State Drive) or other memory technologies, CD-ROM, DVD (Digital Versatile Disc), Blu-ray (registered trademark) disc or other optical disc storage, magnetic cassette, magnetic tape, magnetic disk storage or other magnetic storage devices. The program may be transmitted on transitory computer-readable media or communication media. By way of example and not limitation, transitory computer-readable media or communication media may include propagated signals in electrical, optical, acoustic, or other forms.

What is claimed is:

1. A timing adjustment method for a semiconductor integrated circuit, comprising:
adding one or more dummy cells each having a plurality of dummy metals to layout data of the semiconductor integrated circuit;
selecting a dummy cell to be connected to a signal wiring when the delay time of the signal wiring included in the layout data indicates a hold error, and
connecting one or more of the plurality of dummy metals included in the dummy cell that has been selected in the selecting to the signal wiring.

2. The timing adjustment method according to claim 1,
wherein the plurality of dummy metals have the same shape as each other, and the timing adjustment method further includes determining the number of dummy metals to be connected to the signal wiring from a negative slack value corresponding to the delay time.

3. The timing adjustment method according to claim 2,
wherein the plurality of dummy metals each have a square shape.

4. The timing adjustment method according to claim 2,
wherein adjacent dummy metals of the plurality of dummy metals are arranged so that an interval between the adjacent dummy metals is constant.

5. The timing adjustment method according to claim 1,
wherein one or more of the plurality of dummy metals are used to connect two signal wirings to each other.

6. The timing adjustment method according to claim 1,
wherein in the adding, a dummy cell to be added is selected from a plurality of dummy cells having different dummy metal layout patterns.

7. The timing adjustment method according to claim 6,
wherein the plurality of dummy cells includes a first dummy cell having dummy metals whose direction along the long side is a first direction, and a second dummy cell having dummy metals whose direction along the long side is a second direction orthogonal to the first direction.

8. The timing adjustment method according to claim 1, wherein the plurality of dummy metals in the dummy cell includes a first dummy metal connected to a first signal wiring and a second dummy metal connected to a second signal wiring different from the first signal wiring.

9. A program for causing a computer to execute processes, the processes comprising:
adding one or more dummy cells each having a plurality of dummy metals to layout data of the semiconductor integrated circuit;
selecting a dummy cell to be connected to a signal wiring when the delay time of the signal wiring included in the layout data indicates a hold error, and
connecting one or more of the plurality of dummy metals included in the dummy cell that has been selected in the selecting to the signal wiring.

10. A computer comprising a CPU and a storage unit, the storage unit storing a computer program for executing a plurality of processes on the CPU, the plurality of processes including:
adding one or more dummy cells each having a plurality of dummy metals to layout data of the semiconductor integrated circuit;
selecting a dummy cell to be connected to a signal wiring when the delay time of the signal wiring included in the layout data indicates a hold error, and
connecting one or more of the plurality of dummy metals included in the dummy cell that has been selected in the selecting to the signal wiring.
